(19) United States
(12) Patent Application Publication
(10) Pub. No.: US 2012/0044131 A1
(43) Pub. Date: Feb. 23, 2012

(54) FLAT SCREEN AND HOUSEHOLD APPLIANCE EQUIPPED THEREWITH

(75) Inventors: Hans Klaus Nussbächer, Munchen (DE); Eberhard Weidner, Numberg (DE)

(73) Assignee: BSH BOSCH UND SIEMENS HAUSGERATE GMBH, Munich (DE)

(21) Appl. No.: 13/266,131

(22) PCT Filed: Apr. 26, 2010
(86) PCT No.: PCT/EP2010/055541

§ 371 Date: Oct. 25, 2011

(30) Foreign Application Priority Data
May 14, 2009 (DE) 10 2009 003 128.6

(51) Int. Cl. G09G 3/36

(52) U.S. Cl. 345/87

(57) ABSTRACT

A flat screen includes an LCD matrix display element; a frame, an image field which is surrounded by the frame and set back behind a front face of the frame, and a cover pane disposed in front of the LCD matrix display element. The cover pane has a core zone which is arranged opposite the image field and has a flat inner surface, and a peripheral zone arranged opposite the frame. The flat inner surface of the core zone faces the image field and extends in an intermediate space between the image field and a plane defined by the front face of the frame.

The present invention relates to a flat screen, which can be used in particular but not only in a household appliance. Such a screen can be used to display operating information relating to the household appliance for the user but can also display images that are not or at least not necessarily related to the operation of the household appliance, for example television programs or internet pages.

Many embodiments of flat screens with an LCD matrix display element are known. Conventionally they comprise an image field with two transparent panes, between which a liquid crystal layer is enclosed. Polarizing and in some instances color-filtering layers are configured on the panes. One of the panes also has a matrix of transparent electrodes to which a voltage can be applied individually, opposite which there is a similarly transparent ground coating on the other pane. The panes are enclosed at their edges by a generally metallic frame, which holds the panes together and protects their edges against damage due to impact from a lateral direction.

In practice the display element must also be protected from external influence from a direction perpendicular to the panes, since any deformation of the panes which results in a change in the thickness of the liquid crystal layer impairs image representation. The image field and frame are therefore often additionally protected by a cover pane extending in front of the frame. Such a cover pane can for its part be provided with a transparent, electrically conductive coating, to shield an observer from high-frequency electromagnetic emissions from the flat screen.

The air gap that results between the front pane of the image field and the cover pane is conventionally as least as large as the projection of the frame beyond the front pane. A large distance between image field and cover pane means however that reflections on the surfaces of the cover pane appear with a clear offset compared with the image displayed on the image field for an observer looking at the screen from a direction at an oblique angle to the surface normal, thereby making it difficult to identify the displayed image.

So that reflections on the inside and outside of the cover pane cannot be seen separately, it is desirable per se to use a cover pane of small material thickness. Such a thin cover pane may curve due to inner tensions of the flat screen or its environment, with the result that the displayed image appears distorted to an observer.

One object of the invention is to improve a flat screen of the type mentioned in the introduction so that image errors caused by a cover pane are minimized.

The object is achieved in that in a flat screen with an LCD matrix display element, which comprises a frame and an image field which is surrounded by the frame and set back behind a front face of the frame, and with a cover pane disposed in front of the LCD matrix display element, the cover pane features a core zone opposite the image field and a peripheral zone opposite the frame and a flat inner surface of the core zone facing the image field runs in an intermediate space between the image field and a plane defined by the front face of the frame. In other words the core zone of the cover pane projects into the frame towards the image field, with the result that the air gap that is conventionally present between cover pane and image field becomes narrower. The visible offset between the actual image on the image field and a reflection of said image on the inner surface of the cover pane is reduced as the distance is reduced, so that the reflection can scarcely be seen even when observed at a wide angle.

According to a first elementary embodiment the entire core zone of the cover pane is displaced towards the image field compared with the peripheral zone, for example by deep drawing. Image distortion is then concentrated on a transition region between the core and peripheral zones, in which the cover pane is not flat.

In order to avoid such distortion as well, it is advantageous if the peripheral zone and the core zone of the cover pane have a common outer surface.

To shield electromagnetic emissions from the matrix display element, the cover pane can advantageously be provided with an electrically conductive, transparent coating, in particular of indium tin oxide.

To shield electromagnetic emission effectively, low-resistance grounding of the transparent coating is important. To this end a metallic contact strip can be positioned on the conductive coating—preferably in the peripheral zone.

The coating can be applied to the inner surface of the cover pane so that it is protected from external influences.

In this instance the grounding can be established simply by pressing the contact strip against the similarly metallic frame of the display element.

For production purposes it can be expedient to apply the coatings to the outer surface of the cover pane. This allows a continuous coating to be applied in particular to an extensive substrate, the substrate then to be separated into individual cover panes and the peripheral zones then to be formed on these cover panes.

In this embodiment at least the core zone of the cover pane preferably remains free of the contact strip, so that it does not restrict the visible image field.

A metal tape running around the cover pane can also serve to improve shielding, being in conducting contact with the contact strip.

In particular the metal tape can feature a limb lying flat on the contact strip. However the contact strip itself can also extend over a peripheral surface of the cover pane to touch large areas of the metal tape there.

If an air gap is provided between the inner surface of the core zone and the image field, said air gap preferably has a width of 50 to 250 μm, particularly preferably 100 to 200 μm to prevent the formation of Newton's rings between the opposing surfaces of image field and cover pane.

The subject matter of the invention is also a household appliance, in particular a refrigeration appliance, having a flat screen of the type described above. Such a flat screen can be positioned in particular in the door of the household appliance, with an outer face of the door being formed in its entirety by a glass plate, behind which the flat screen is located.

Further features and advantages of the invention will emerge from the description which follows of exemplary embodiments with reference to the accompanying figures, in which:

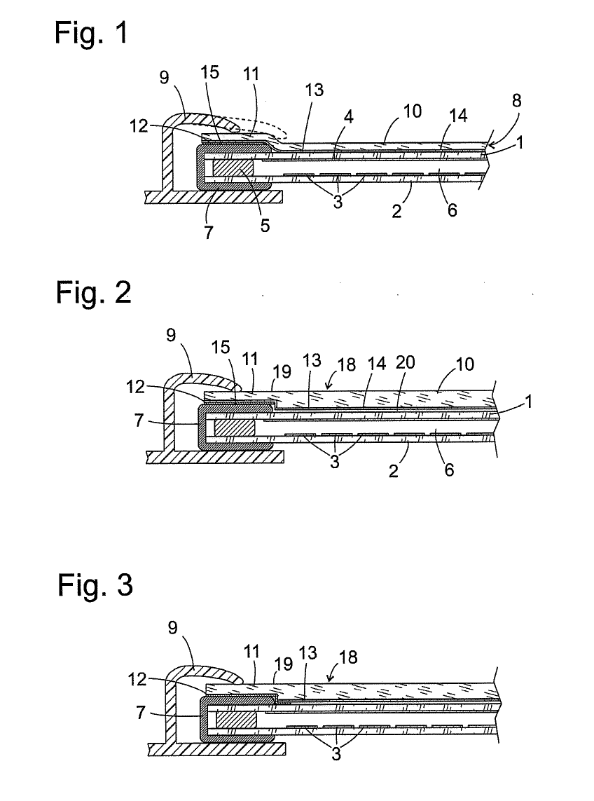

FIGS. 1 to 8 each show a partial section through a flat screen according to different embodiments of the invention; and

FIG. 9 shows a schematic perspective view of a refrigeration appliance having an incorporated flat screen.

FIG. 1 shows a cross section through the peripheral region of a flat screen according to a first embodiment of the invention. The side from which the screen can be observed is at the top in FIG. 1; a scatter surface irradiated by a light source, by which the screen is evenly illuminated from the rear and bottom, is not shown. Two panes 1, 2 made of mineral glass or a crystal-clear plastic material are provided with the standard coatings for LCD display elements, such as polarization coatings (not shown), individually activatable transparent pixel electrodes 3 and an unstructured ground electrode 4. The surface covered by the pixel electrodes 3 corresponds to the region of the screen that can be used to display images, also referred to here as the image field. In an intermediate space, which is kept free by spacers 5 and sealed at the sides, between the glass plates 1 is a liquid crystal solution 6. The rectangular glass plates 1, 2 are enclosed along their edges by a continuous frame 7, which is made up of metallic U-profiles.

A cover pane 8 made of a rigid, moderately elastic thermoplastic plastic material is held pressed against the outside of the frame 7 by a peripheral plastic enclosure 9. The cover pane 8 is deformed by deep drawing, so that a core zone 10 of it engages in the frame 7 and the distance between the pane 1 and an inner surface 14 of the core zone 10 is much smaller than between the pane 1 and an outside 15 of the frame 7 facing away from the pane 1. A shielding conductive transparent coating 13 made of indium tin oxide on the inside of the cover pane 8 is provided in a non-deformed peripheral zone 11 of the cover pane 8 extending around the core zone 10 with a metallic contact strip 12 that has been printed, chemically deposited or applied in some other suitable manner with little electrical transfer resistance to the coating 13. This contact strip 12 rests on the frame 7 due to the pressure of the enclosure 9, thereby ensuring effective grounding of the conductive coating 13 on the frame 7.

Since in this embodiment there is practically no intermediate space between the cover pane 8 and the glass plate 1 and the width of such an intermediate space may be in the region of a few μm over large areas, it is expedient to roughen the inner surface of the cover pane 8 facing the pane 1 before applying the conductive coating 13, for example by impressing an irregular pattern, to prevent Newton's rings becoming visible.

In order to prevent image distortions resulting from the unevenness of the cover pane 8 in the transition region between core zone 10 and peripheral zone 11 becoming perceptible, it is expedient with this embodiment if the entire exposed surface of the plates 1, 2 within the frame 7 is not used for image display. Also the enclosure 9, as outlined with a broken line, can be made so wide that it covers the peripheral zone 11 and the uneven transition to the core zone 10 completely.

FIG. 2 shows a second embodiment of the flat screen in a section like the one in FIG. 1. The matrix display element with the glass plates 1, 2 and the frame 7 surrounding them is identical to the one in FIG. 1 and is not described again. As in FIG. 1, a cover pane 18 has a peripheral zone 11 pressed onto the outside of the frame 7 and a core zone 10 engaging in the frame 7 but both have a common flat outer surface 19 and the material thickness of the core zone 10 is greater than that of the peripheral zone 11. The cover pane 18 is therefore much more rigid in its core zone 10 than the cover pane of a conventional flat screen of the same incorporated depth, so that despite the reduced distance it can protect the matrix element effectively against damage due to impact by an object. The wall thicknesses of the core and peripheral zones 10, 11 are tailored to the dimensions of the frame 7, to maintain an air gap 20 between the cover pane 18 and the outer glass plate 1 of typically around 100 μm width. Such a distance is sufficient to prevent the occurrence of Newton's rings but at the same time small enough for a reflection on the inside of the cover pane 18 not to be perceived as problematic by an observer.

In this embodiment, as in the one in FIG. 1, the cover pane 18 is covered completely on its inner surface with a shielding conductive coating 13. In the peripheral zone 11 the coating 13 is completely covered by the metallic contact strip 12, since the three-dimensional contour of the inside of the cover pane 18 makes it difficult to restrict the contact strip 12 to part of the width of the peripheral zone 11. The contact strip 12 therefore also conceals the frame 7 and, in so far as the dimensions of this core zone 10 do not correspond exactly to the exposed surface of the glass plate 1 within the frame 7, also a peripheral region of this. This is no longer problematic if the entire exposed surface of the glass plate 1 is not used to display images.

If the latter is the case, an embodiment as shown in FIG. 3 is possible, in which the conductive coating 13 is restricted to the core zone of the cover pane 18. To ground the coating 13 reliably, the contact strip 12 not only covers the entire peripheral zone 11 but also overlaps in a narrow peripheral region of the core zone 10 with the coating 13 applied thereto.

The latter embodiment has the advantage that it allows simple and economical production of the cover pane 18, in that the conductive coating 13 is first applied continuously to a large-format plate of even thickness and the plate is then broken into pieces and a peripheral zone 11 is produced on each of these pieces by pressing or by abrasive processing, said peripheral zone 11 having a smaller material thickness than the core zone 10 that remains unprocessed.

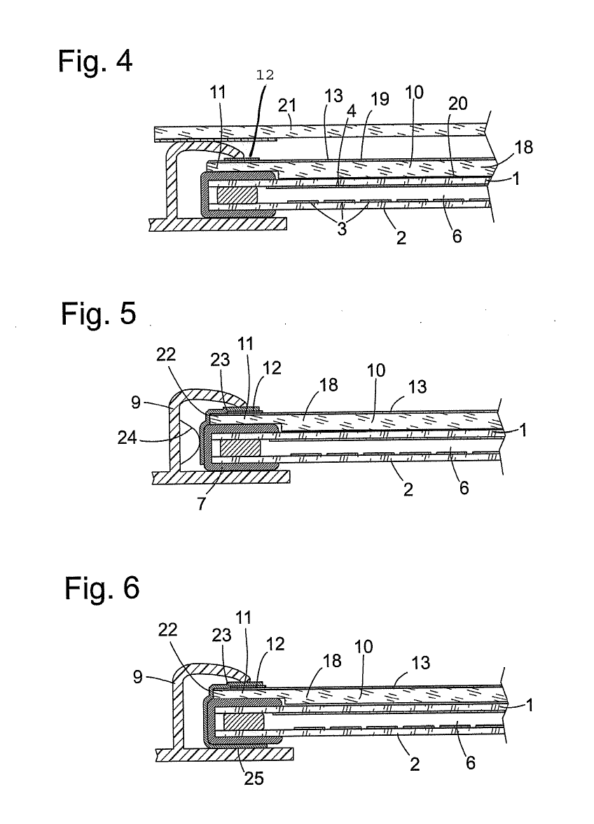

If the exposed surface of the plate 1, 2 is used in its entirety to display images, it is not desirable for part of this surface to be covered by the contact strip 12. An embodiment as shown in FIG. 4 is then expedient, wherein the conductive coating 13 and with it the contact strip 12 is applied to the flat outer surface 19 of the cover pane 18. To protect the coating 13 from wear, a scratch-resistant coating, known from eye glasses for example, can be applied to it. Such a coating may be omitted, if the entire flat screen, as illustrated in FIG. 4, is incorporated for its part behind a transparent pane 21 of an appliance housing. This pane 21 is expediently provided with a non-reflective coating, since otherwise, because of its distance of several mm from the matrix display element, reflections occurring at its surfaces could be perceived separately from the actual image by an observer looking at the screen from a direction away from the surface normal.

To establish a low-resistance electrical contact between the contact strip 12 and the frame 7, as desired for effective electromagnetic shielding of the matrix display element, in a development shown in FIG. 5 a thin metal tape 22 is wound around the outer edge of the frame 7 and the cover pane 18 and folded onto the outside of the cover pane 18, where a limb 23 of the metal tape 22 is kept pressed against the contact strip 12 by the enclosure 9. To ensure close electrical contact between the metal tape 22 and the frame 7 or contact strip 12, an electrically conducting bonding agent can also be used, or the metal tape 22 can be held pressed against the outer edge of the frame 7 by a leaf spring 24.

In the embodiment in FIG. 6 the metal tape 22 not only has a limb 23 pressed against the contact strip 12 on the outside of the cover pane 18 but also a limb 25 held clamped between the enclosure 9 and a rear face of the frame opposite this.

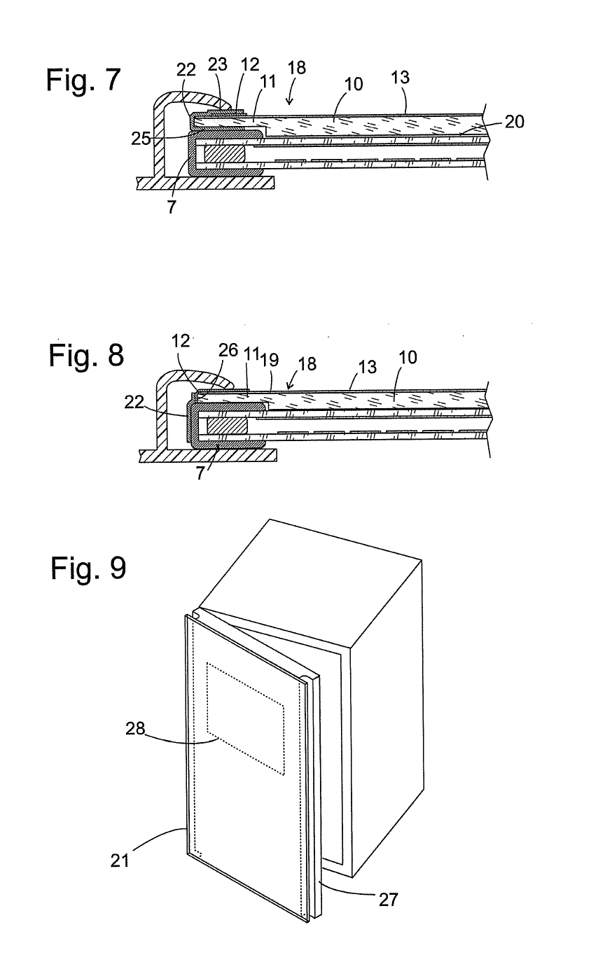

According to a modification shown in FIG. 7 a second limb 25 of the metal tape 22 can also be clamped between the peripheral zone 11 of the cover pane 18 and the front face of the frame 7. This allows the thickness of the core zone 10 to be increased by the material thickness of the metal tape 22 whilst still maintaining the width of the air gap 20, thereby making the cover pane 18 more rigid.

It is also possible to position the contact strip 12, as illustrated in FIG. 8, not only on one of the main surfaces of the cover pane 18 but also along its narrow sides 26. This allows low-resistance electrical contact to be established between the contact strip 12 and the frame 7 by means of a metal tape 22 which does not have an angled limb but simply extends along the outside of the frame 7 and the narrow sides 26 of the cover pane 18.

The coating 13, the frame 7 and where present the metal tape 22 connecting them together form a conductive flat shell, which is pulled over the matrix display element to shield a user from its emissions beyond the cover pane 18 and to reflect them in the counter direction or absorb them.

This shielding effect is also not impaired by openings in the shell, as long as these are smaller than the wavelength of the radiation to be shielded. Therefore for example the frame 7 does not have to touch the cover plate 18 over its entire periphery but for example grooves can be formed in the front face of the frame or local breaks can be formed in the contact strip 12, through which an air exchange is possible between the air gap 20 and the environment. Therefore if moisture enters the air gap 20, it can also quickly escape again and there is no sustained interference with the image display due to condensate deposited on the facing surfaces of the cover pane 18 and the plate 1.

FIG. 9 shows a refrigeration appliance as one example of the application of the flat screen, the flat screen being incorporated in the front face of the door 27 here. The entire front face of the door 27 is taken up by a glass plate 21, which like the pane 21 in FIG. 4 covers the entire flat screen. The glass plate 21 is printed in a non-transparent manner on its rear face, with the exception of a central blank space 28, behind which the flat screen is positioned. The edges of this blank space 28 correspond precisely to the region of the plates 1, 2 used for the image display, so that the frame 7 and the peripheral zone 11 of the cover pane 18 and together with these also the contact strip 12 and where applicable the metal tape 22 are concealed.

1-14. (canceled)

15. A flat screen, comprising:
an LCD matrix display element;
a frame;
an image field which is surrounded by the frame and set back behind a front face of the frame; and
a cover pane disposed in front of the LCD matrix display element, said cover pane including a core zone which is arranged opposite the image field and has a flat inner surface, and a peripheral zone arranged opposite the frame, said flat inner surface of the core zone facing the image field and extending in an intermediate space between the image field and a plane defined by the front face of the frame.

16. The flat screen of claim 15, wherein the peripheral zone and the core zone of the cover pane have a common flat outer surface.

17. The flat screen of claim 15, wherein the cover pane is provided with an electrically conductive transparent coating.

18. The flat screen of claim 17, further comprising a metallic contact strip positioned on the coating.

19. The flat screen of claim 17, wherein the coating is applied to the inner surface of the core zone.

20. The flat screen of claim 18, wherein the contact strip is pressed against a metallic frame of the display element.

21. The flat screen of claim 18, wherein the coating is applied to an outer surface of the cover pane.

22. The flat screen of claim 21, wherein a part of the outer surface free of the contact strip extends over at least the core zone in its entirety.

23. The flat screen of claim 18, further comprising a metal tape running around the cover pane and provided in conducting contact with the contact strip.

24. The flat screen of claim 23, wherein the metal tape includes an angled limb lying flat on the contact strip.

25. The flat screen of claim 23, wherein the contact strip extends over a peripheral surface of the cover pane.

26. The flat screen of claim 15, wherein the inner surface of the core zone and the image field defines an air gap having a width of 50 to 250 μm.

27. The flat screen of claim 15, wherein the inner surface of the core zone and the image field defines an air gap having a width of 100-200 μm.

28. A household appliance, comprising a flat screen including an LCD matrix display element, a frame, an image field which is surrounded by the frame and set back behind a front face of the frame, and a cover pane disposed in front of the LCD matrix display element, said cover pane including a core zone which is arranged opposite the image field and has a flat inner surface, and a peripheral zone arranged opposite the frame, said flat inner surface of the core zone facing the image field and extending in an intermediate space between the image field and a plane defined by the front face of the frame.

29. The household appliance of claim 28, constructed in the form of a refrigeration appliance.

30. The household appliance of claim 28, wherein the peripheral zone and the core zone of the cover pane have a common flat outer surface.

31. The household appliance of claim 28, wherein the cover pane is provided with an electrically conductive transparent coating.

32. The household appliance of claim 31, further comprising a metallic contact strip positioned on the coating.

33. The household appliance of claim 31, wherein the coating is applied to the inner surface of the core zone.

34. The household appliance of claim 32, wherein the contact strip is pressed against a metallic frame of the display element.

35. The household appliance of claim 32, wherein the coating is applied to an outer surface of the cover pane.

36. The household appliance of claim 35, wherein a part of the outer surface free of the contact strip extends over at least the core zone in its entirety.

37. The household appliance of claim 32, further comprising a metal tape running around the cover pane and provided in conducting contact with the contact strip.

38. The household appliance of claim 37, wherein the metal tape includes an angled limb lying flat on the contact strip.

39. The household appliance of claim 37, wherein the contact strip extends over a peripheral surface of the cover pane.

40. The household appliance of claim 28, wherein the inner surface of the core zone and the image field defines an air gap having a width of 50 to 250 μm.

41. The household appliance of claim 28, wherein the inner surface of the core zone and the image field defines an air gap having a width of 100-200 μm.

42. The household appliance of claim 28, further comprising a door having an outer surface formed by a glass plate, said flat screen being positioned behind the glass plate.
